(19) United States
(12) Patent Application Publication
(10) Pub. No.: US 2026/0134492 A1
(43) Pub. Date: May 14, 2026

(54) AUTONOMOUS AGENT ACCOUNTABILITY AND LIABILITY ATTRIBUTION SYSTEM

(71) Applicant: George William Bickerstaff, III, Greenwich, CT (US)

(72) Inventor: George William Bickerstaff, III, Greenwich, CT (US)

(21) Appl. No.: 19/443,691

(22) Filed: Jan. 8, 2026

(51) Int. Cl. G06Q 50/18

(52) U.S. Cl. CPC G06Q 50/18

(57) ABSTRACT

An autonomous agent accountability and liability attribution system is disclosed that assigns responsibility for actions performed by autonomous agents by capturing intent, delegation, execution context, and outcomes. The system generates immutable accountability records suitable for legal, regulatory, and insurance use, enabling scalable deployment of autonomous systems in regulated environments.

### TECHNICAL FIELD

The present invention relates to autonomous and artificial intelligence systems and, more particularly, to systems and methods for attributing accountability and legal responsibility for actions performed by autonomous agents.

### BACKGROUND

Autonomous systems increasingly perform actions with material legal, financial, and operational consequences. Such actions may include executing transactions, allocating resources, controlling infrastructure, making recommendations, or interacting with humans and other systems. Existing accountability frameworks are designed for human decision-makers and do not adequately address responsibility attribution in environments where actions are initiated, delegated, or executed by autonomous agents.

In the absence of technical accountability mechanisms, organizations face heightened legal exposure, regulatory uncertainty, and challenges in insurance underwriting and dispute resolution. Determining responsibility for autonomous actions often requires manual reconstruction of logs and subjective interpretation, which is error-prone and insufficient for real-time or large-scale autonomous systems. There is therefore a need for a technical system that deterministically attributes responsibility for autonomous actions by tracing intent, delegation, execution, and outcomes in a machine-verifiable manner.

### SUMMARY OF THE INVENTION

The invention provides an autonomous agent accountability and liability attribution system that assigns responsibility for actions performed by autonomous agents by capturing and correlating intent, delegation authority, execution context, and resulting outcomes. The system generates machine-verifiable accountability records that identify responsible entities, support legal and regulatory review, and integrate with insurance and risk management frameworks.

The system operates in real time or near real time and produces immutable evidence artifacts suitable for compliance, dispute resolution, and litigation defense. By embedding accountability attribution directly into autonomous execution pathways, the invention enables scalable deployment of autonomous systems in regulated and high-risk environments.

### Definitions (Alphabetical)

Accountable Entity: A person, organization, or system assigned responsibility for an autonomous action.

Action Outcome: A result produced by execution of an autonomous action.

Action Proposal: A request generated by an autonomous agent to perform an operation.

Delegation Chain: A record of authority transfer between entities or agents.

Evidence Artifact: A machine-generated record supporting accountability determination.

Execution Context: Technical and operational conditions under which an action occurs.

Intent Record: A representation of purpose or objective associated with an action.

Liability Attribution Engine: A component that assigns responsibility based on execution data.

Risk Interface: A system interface exposing accountability data to insurers or risk systems.

Responsibility Score: A quantified measure of accountability assigned to an entity.

### BRIEF DESCRIPTION OF THE DRAWINGS

FIG. 1 illustrates intent and delegation capture.

FIG. 2 illustrates execution responsibility mapping.

FIG. 3 illustrates liability attribution processing.

FIG. 4 illustrates risk and insurance integration.

FIG. 5 illustrates legal evidence generation and storage.

### DETAILED DESCRIPTION OF THE INVENTION

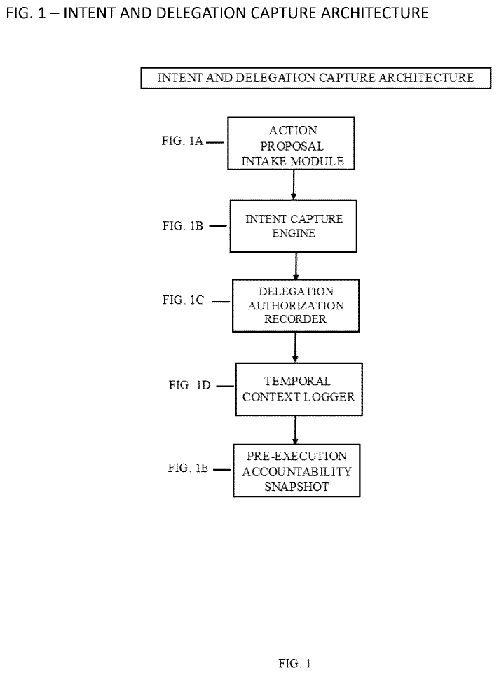

### FIG. 1—Intent and Delegation Capture Architecture

FIG. 1A illustrates an action proposal intake module in which an autonomous agent generates an action proposal describing an intended operation. The proposal includes metadata describing purpose and scope and is registered prior to execution.

FIG. 1B illustrates an intent capture engine that extracts and records an intent record associated with the action proposal. Intent may be derived from objectives, constraints, or learned policies and is cryptographically bound to the proposal.

FIG. 1C illustrates a delegation authorization recorder that identifies authority under which the action is performed. Delegation relationships between entities or agents are captured to form a delegation chain.

FIG. 1D illustrates a temporal context logger that records time-based execution parameters and preserves sequencing of delegation and intent.

FIG. 1E illustrates a pre-execution accountability snapshot that combines intent, delegation, and execution context into an immutable record prior to execution.

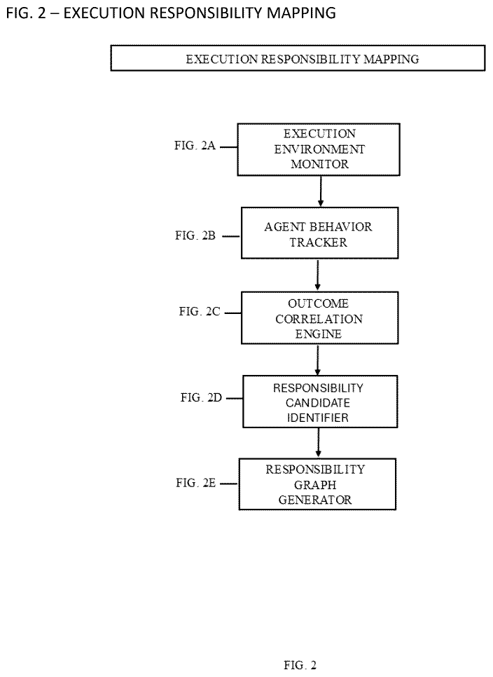

### FIG. 2—Execution Responsibility Mapping

FIG. 2A illustrates an execution environment monitor that observes execution conditions, system interactions, and resource usage during action performance.

FIG. 2B illustrates an agent behavior tracker that continuously monitors agent behavior and identifies deviations from expected execution patterns.

FIG. 2C illustrates an outcome correlation engine that correlates action outcomes with intent records, delegation chains, and execution context.

FIG. 2D illustrates a responsibility candidate identifier that deterministically identifies one or more accountable entities based on correlated execution data.

FIG. 2E illustrates a responsibility graph generator that maps relationships between candidates and execution elements using graph structures to support attribution analysis.

### Example Autonomous Action Accountability Scenario

In one example embodiment, an autonomous agent generates an action proposal to perform an operational task. The action proposal is received by the action proposal intake module illustrated in FIG. 1A prior to execution.

An intent record associated with the action proposal is captured by the intent capture engine illustrated in FIG. 1B. Authority under which the action is performed is recorded by the delegation authorization recorder illustrated in FIG. 1C, producing a validated delegation chain. Temporal execution conditions are recorded by the temporal context logger illustrated in FIG. 1D, and a pre-execution accountability snapshot is generated as illustrated in FIG. 1E.

During execution, the execution environment monitor illustrated in FIG. 2A and the agent behavior tracker illustrated in FIG. 2B observe execution conditions and agent behavior. Resulting action outcomes are correlated with intent and delegation data by the outcome correlation engine illustrated in FIG. 2C.

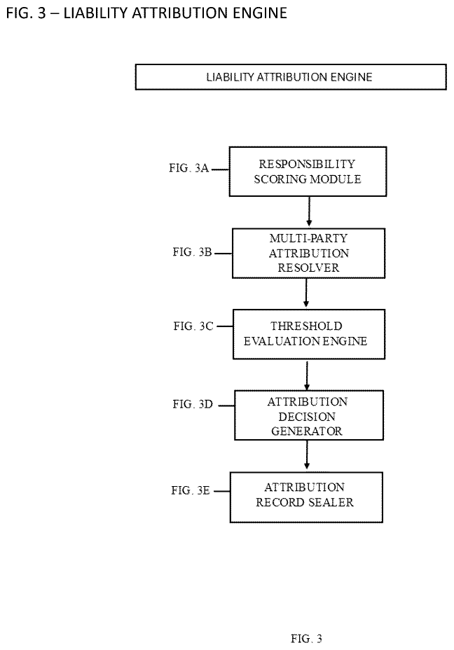

Based on correlated execution data, the responsibility candidate identifier illustrated in FIG. 2D identifies one or more accountable entities. A responsibility graph is generated by the responsibility graph generator illustrated in FIG. 2E, and the liability attribution engine illustrated in FIG. 3 assigns responsibility using explainable responsibility scoring. An attribution record is sealed for downstream risk, insurance, and legal use.

This example is provided for illustrative purposes only, and the invention is not limited to the specific sequence, entities, or outcomes described.

### FIG. 3—Liability Attribution Engine

FIG. 3A illustrates a responsibility scoring module that assigns a responsibility score to each accountable entity based on degree of control, intent, and execution influence.

FIG. 3B illustrates a multi-party attribution resolver that allocates proportional responsibility among multiple entities when applicable.

FIG. 3C illustrates a threshold evaluation engine that evaluates responsibility scores against legal or policy thresholds.

FIG. 3D illustrates an attribution decision generator that produces machine-readable attribution determinations with supporting rationale.

FIG. 3E illustrates an attribution record sealer that seals attribution determinations into immutable, time-stamped records.

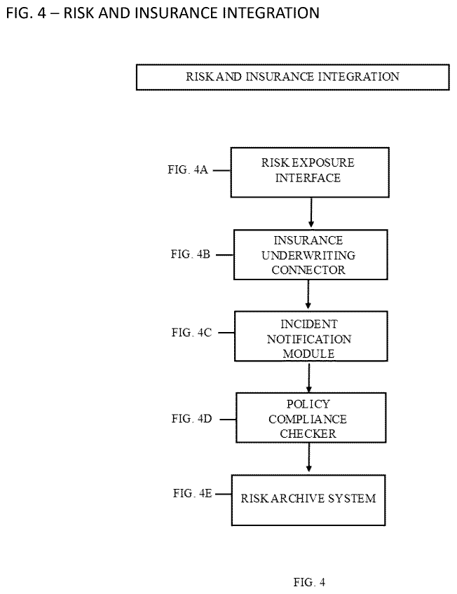

### FIG. 4—Risk and Insurance Integration

FIG. 4A illustrates a risk exposure interface that exposes accountability data to risk management systems.

FIG. 4B illustrates an insurance underwriting connector that integrates attribution data into underwriting models.

FIG. 4C illustrates an incident notification module that triggers notifications based on attribution events.

FIG. 4D illustrates a policy compliance checker that evaluates attribution outcomes against insurance or operational policies.

FIG. 4E illustrates a risk archive system that securely stores risk-related accountability data.

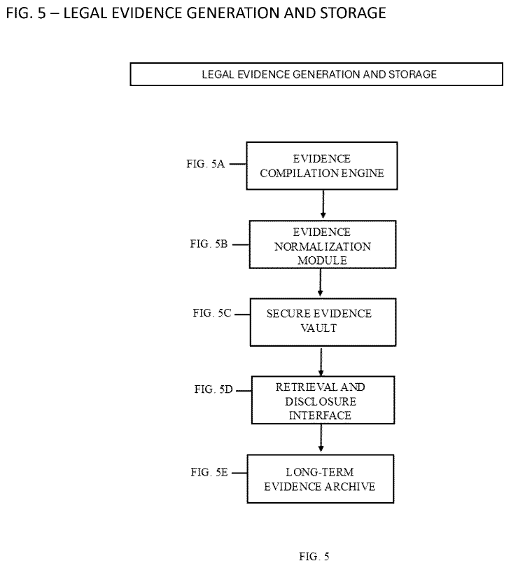

### FIG. 5—Legal Evidence Generation and Storage

FIG. 5A illustrates an evidence compilation engine that aggregates accountability data into structured evidence artifacts.

FIG. 5B illustrates an evidence normalization module that formats artifacts to satisfy jurisdiction-specific legal requirements.

FIG. 5C illustrates a secure evidence vault that stores evidence artifacts with integrity verification.

FIG. 5D illustrates a retrieval and disclosure interface that controls authorized access to evidence.

FIG. 5E illustrates a long-term evidence archive that preserves accountability records for litigation defense and regulatory inquiries.

1. An autonomous agent accountability system comprising:
an intent capture engine configured to record purpose associated with an autonomous action;
a delegation recorder configured to capture authority relationships; and
a liability attribution engine configured to assign responsibility based on execution outcomes.

2. A method for attributing responsibility for autonomous actions comprising:
recording intent and delegation prior to execution;
monitoring execution and outcomes; and
assigning responsibility based on correlated execution data.

3. A non-transitory computer-readable medium storing instructions that cause a system to generate machine-verifiable accountability records for autonomous actions.

4. The system of claim 1, wherein responsibility is allocated among multiple entities.

5. The method of claim 2, wherein responsibility scores are threshold-evaluated.

6. The system of claim 1, further comprising integration with insurance underwriting systems.

7. The method of claim 2, wherein accountability records are immutable.

8. The system of claim 1, wherein human escalation is triggered upon ambiguity.

9. The computer-readable medium of claim 3, wherein evidence artifacts are jurisdiction-aware.

10. The system of claim 1, wherein accountability records are legally admissible.
